(19) United States
(12) Patent Application Publication
(10) Pub. No.: US 2016/0303925 A1
(43) Pub. Date: Oct. 20, 2016

(54) TIRE PRESSURE DETECTOR SET WITH BLUETOOTH SIGNAL CONVERSION FUNCTION

(71) Applicant: GOFULL TECHNOLOGY CO., LTD., Hsinchu City (TW)

(72) Inventors: CHI-KANG LIU, HSINCHU CITY (TW); YUN-HUNG SHEN, HSINCHU CITY (TW)

(21) Appl. No.: 14/745,580

(22) Filed: Jun. 22, 2015

(30) Foreign Application Priority Data
Apr. 17, 2015 (TW) 104112435

(51) Int. Cl. B60C 23/04

(52) U.S. Cl. CPC B60C 23/0435; B60C 23/0433; B60C 23/0486

(57) ABSTRACT

The present invention discloses a tire pressure detector set with a Bluetooth signal conversion function, which is installed in a vehicle and comprises at least one tire pressure detection element and a signal conversion element. The tire pressure detection element is installed in a wheel of the vehicle, detects information of the wheel, and transmits a Bluetooth signal. The signal conversion element is installed in the vehicle, receives the Bluetooth signal, undertakes data format conversion and converts the Bluetooth signal into an RF signal according to the model code of the vehicle and the data format required by an in-vehicle central control system, and transmits the RF signal to a wireless RF receiver of the in-vehicle central control system.

This application claims priority for Taiwan patent application no. 104112435 filed on Apr. 17, 2015, the content of which is incorporated by reference in its entirely.

### BACKGROUND OF THE INVENTION

1. Field of the Invention

The present invention relates to a tire pressure detector technology, particularly to a tire pressure detector set with a Bluetooth signal conversion function.

2. Description of the Related Art

Many traffic accidents are attributed to tire explosions or wheel falling off. While a vehicle is running on a free way at a high speed or for a long distance, the wheels are likely to be overheated and overpressurized. In such a case, the probability of tire explosion increases. Thus, tire pressure detectors were developed to solve the problem. Each wheel is equipped with a tire pressure detector, and the signals thereof are transmitted to a central control system. Once a tire pressure detector detects abnormality, the central control system warns the driver of the danger.

The current tire pressure detectors transmit signals at a radio frequency of 433 or 315 MHz, and the central control systems can only receive signals of the same frequency. However, the signals of different vehicles or different wheels are likely to interfere mutually because of only a single transmission frequency used by many signal sources and a long distance between the wheels and the central control system. Besides, the signals carried by a radio frequency are transmitted at a slower rate. Thus, radio frequency transmission takes longer time and consumes more power. Further, the tire pressure detectors of different manufacturers may use different data formats. Even the tire pressure detectors of different styles or models of the same automobile manufacturer may use different data formats. Therefore, tire pressure detectors of different manufacturers or different model codes of automobiles cannot exchange mutually. Moreover, the current tire pressure detectors cannot communicate bidirectionally but can only transmit information unidirectionally. For bidirectional communication, the current tire pressure detector need equipping with a low-frequency receiver. These problems mentioned above are all owing to that tire pressure detectors use radio frequency signals to transmit data to central control systems. A Taiwan patent No. I293926 disclosed a programmable universal tire pressure detector and a method thereof, wherein an encoding device is built in the tire pressure detector and generates signals whose format matches an external monitor device. However, the prior art needs to program the tire pressure detector of each wheel. Furthermore, tire pressure detectors using Bluetooth signals to transmit information are growing popular. However, the original in-vehicle central control systems still operate at the frequency band of 433 or 315 MHz, neither compatible with the new Bluetooth tire pressure detectors nor able to receive the signals of the new Bluetooth tire pressure detectors.

Accordingly, the present invention proposes a tire pressure detector set with a Bluetooth signal conversion function, which converts the signals of the tire pressure detector into Bluetooth signals and transforms the Bluetooth signals into radio frequency signals to an in-vehicle central control system, whereby to overcome the abovementioned problems. The technical scheme and embodiments thereof will be described in detail below.

### SUMMARY OF THE INVENTION

The primary objective of the present invention is to provide a tire pressure detector set with a Bluetooth signal conversion function, whose signal conversion element converts the Bluetooth signals of a tire pressure detection element into radio frequency signals, whereby the information sent out by the tire pressure detection element can be received by an in-vehicle central control system that can only receive radio frequency signals.

Another objective of the present invention is to provide a tire pressure detector set with a Bluetooth signal conversion function, whose signal conversion element is arranged inside a vehicle, whereby the signal conversion element is nearer to the in-vehicle central control system, and whereby the mutual signal interference between different vehicles is reduced, and whereby the user needn't install signal conversion elements in all wheels, wherefore the equipment cost is reduced.

Yet another objective of the present invention is to provide a tire pressure detector set with a Bluetooth signal conversion function, wherein the communication of the tire pressure detection element and the signal conversion element are based on Bluetooth technology, whereby the user can use a mobile device (such as a smart phone or a tablet computer) to control the tire pressure detection element and the signal conversion element.

Still another objective of the present invention is to provide a tire pressure detector set with a Bluetooth signal conversion function, whose signal conversion element is a vehicular charging device (such as an electric cigarette lighter or an electric charger), whereby the mobile device plugged in the signal conversion element can be charged and transceive signals simultaneously.

Further another objective of the present invention is to provide a tire pressure detector set with a Bluetooth signal conversion function, wherein the data format is recorded in the signal conversion element, whereby the data size of the Bluetooth signals is reduced and the transmission speed is increased.

To achieve the abovementioned objectives, the present invention proposes a tire pressure detector set with a Bluetooth signal conversion function, which comprises at least one tire pressure detection element and a signal conversion element, wherein the tire pressure detection elements are installed in wheels of a vehicle for detecting information of the wheels and sending out Bluetooth signals, and wherein the signal conversion element is installed inside the vehicle, preferably at a position nearer to the in-vehicle central control system, and wherein the signal conversion element receives the Bluetooth signals, converts the Bluetooth signals into radio frequency signals according to the model code of the vehicle and a data format required by the in-vehicle central control system, and then transmits the radio frequency signals to a wireless radio frequency receiver of the in-vehicle central control system.

Below, embodiments are described in detail to make easily understood the objectives, technical contents, characteristics and accomplishments of the present invention.

### BRIEF DESCRIPTION OF THE DRAWINGS

FIG. 1A and FIG. 1B are diagrams schematically showing that a tire pressure detector set with a Bluetooth signal conversion function is installed in a vehicle according to one embodiment of the present invention;

FIG. 2 is a flowchart of the process of the operation of the tire pressure detection element of a tire pressure detector set with a Bluetooth signal conversion function according to one embodiment of the present invention;

FIG. 3 is a flowchart of the process of the operation of the signal conversion element of a tire pressure detector set with a Bluetooth signal conversion function according to one embodiment of the present invention; and

FIG. 4A and FIG. 4B are diagrams schematically showing the data formats of the tire pressure detection elements of two different model codes of vehicles.

### DETAILED DESCRIPTION OF THE INVENTION

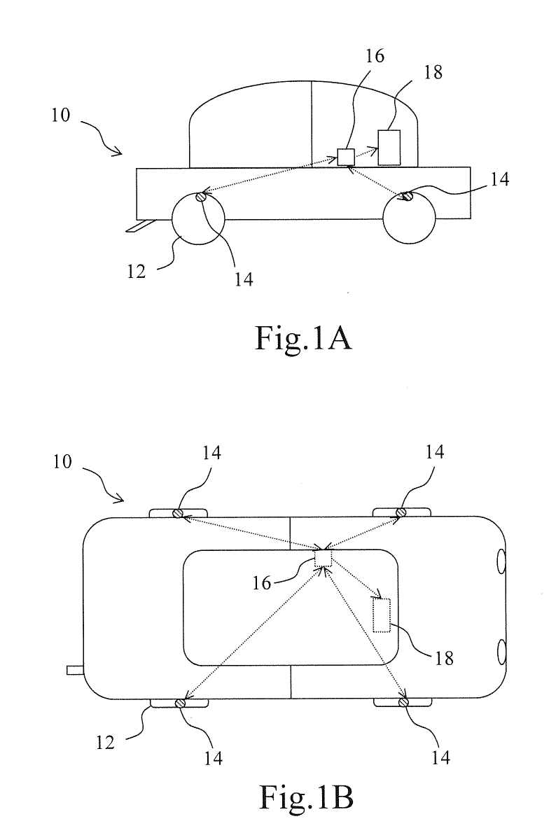

Refer to FIG. 1A and FIG. 1B diagrams schematically showing that a tire pressure detector set with a Bluetooth signal conversion function is installed in a vehicle according to one embodiment of the present invention.

The tire pressure detector set with a Bluetooth signal conversion function of the present invention comprises at least one tire pressure detection element 14 and a signal conversion element 16, which are installed in a vehicle 10. The tire pressure detection elements 14 are installed in wheels 12 of the vehicle 10. Preferably, the tire pressure detection element 14 is installed in each of the wheels 12. The signal conversion element 16 is installed at a position nearer to an in-vehicle central control system 18.

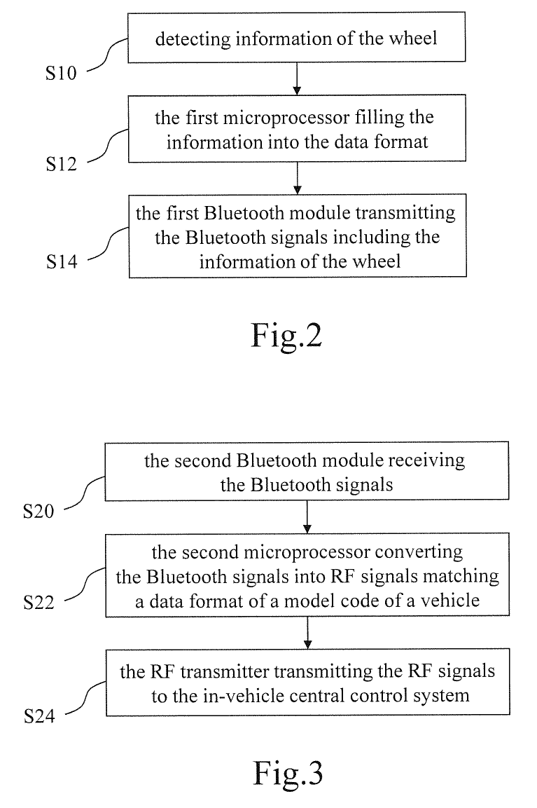

The tire pressure detection element 14 has a first Bluetooth module (not shown in the drawing) and a first microprocessor (not shown in the drawing). Refer to FIG. 2 for a flowchart of the process of the operation of a tire pressure detection element of a tire pressure detector set with a Bluetooth signal conversion function according to one embodiment of the present invention. In Step S10, the tire pressure detection element 14 detects the information of the wheel 12, including the information of temperature, pressure, and battery voltage of the wheel 12. In Step S12, the first microprocessor fills the information into the data format of the tire pressure detection element 14. In Step S14, the first Bluetooth module transmits the Bluetooth signals of information, including the information of temperature, pressure, and battery voltage, to the signal conversion element 16.

The signal conversion element 16 has a second Bluetooth module (not shown in the drawing), a second microprocessor (not shown in the drawing), and a radio frequency (RF) transmitter (not shown in the drawing). Refer to FIG. 3 for a flowchart of the process of the operation of a signal conversion element of a tire pressure detector set with a Bluetooth signal conversion function according to one embodiment of the present invention. In Step S20, the second Bluetooth module of the signal conversion element 16 receives the Bluetooth signals transmitted by the tire pressure detection element 14. In Step S22, the second microprocessor converts the Bluetooth signals, which are received by the second Bluetooth module from the tire pressure detection element 14, into RF signals according to the model code of the vehicle 10 and a data format required by the in-vehicle central control system 18. In Step S24, the RF transmitter of the signal conversion element 16 transmits the RF signals to an RF receiver (not shown in the drawing) of the in-vehicle central control system 18.

Both the first Bluetooth module of the tire pressure detection element 14 and the second Bluetooth module of the signal conversion element 16 are based on the Bluetooth low energy technology. Therefore, the first Bluetooth module and the second Bluetooth module consume less power. Thus, the tire pressure detection element 14 can operate normally for a longer period of time. In normal cases, the in-vehicle central control system 18 cannot receive Bluetooth signals but can only receive RF signals. The RF signals generated by the signal conversion element 16 are at a frequency band of 315 or 433 MHz. The signal conversion element 16 installed inside the vehicle 10 and at a position nearer to the in-vehicle central control system 18 so as to prevent the RF signals from being interfered with by other signals and prevent the RF signals from being received by other vehicles.

The present invention stores the data formats of tire pressure detection elements of different manufacturers or different model codes of vehicles in the signal conversion element 16 or the cloud database (not shown in the drawing). Therefore, even though different tire pressure detection elements 14 transmit data of different formats, the signal conversion element 16 can convert the Bluetooth signals of different formats of data into RF signals and transmit the RF signals to the in-vehicle central control system 18. Further, the design that the data formats are not stored in the tire pressure detection element 14 but stored in the signal conversion element 16 exempts the Bluetooth signals from carrying the data format, decreasing the data size of the Bluetooth signals and increasing the transmission speed of the Bluetooth signals.

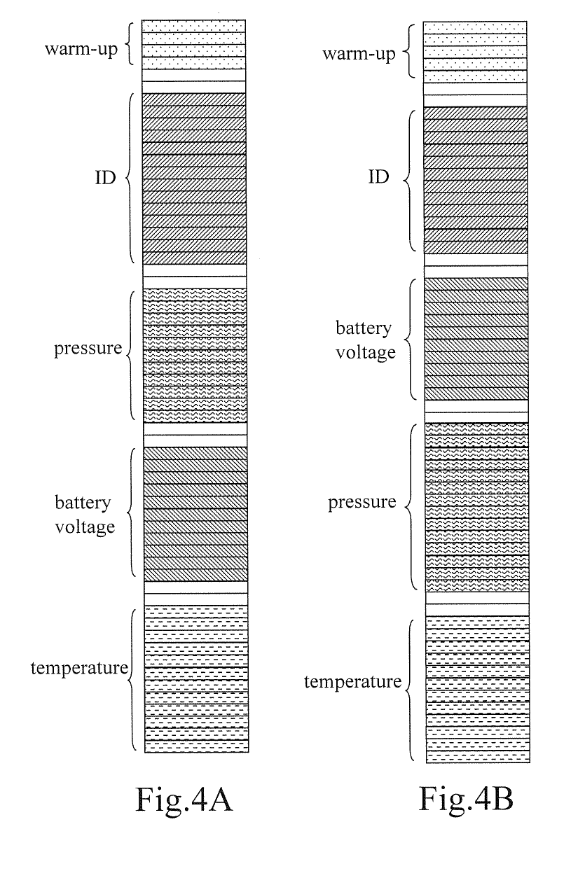

Refer to FIG. 4A and FIG. 4B diagrams schematically showing the data formats of the tire pressure detection elements of two different model codes of vehicles. In FIG. 4A and FIG. 4B, each data format has information of the identification code of the tire pressure detection element, pressure, battery voltage, and wheel temperature, which respectively occupy different digital bits and are stored in different sequences for the tire pressure detection elements of different manufacturers or different model codes of vehicles. In FIG. 4A, the data format includes 4 bits for warm-up, 14 bits for an identification code, 11 bits for pressure, 11 bits for battery voltage, and 12 bits for temperature in sequence. In FIG. 4B, the data format includes 5 bits for warm-up, 10 bits for an identification code, 10 bits for battery voltage, 14 bits for pressure, and 12 bits for temperature in sequence. Therefore, the data format in FIG. 4B has one more bit than the data format in FIG. 4A; the pieces of data are stored in different sequences and respectively occupy different quantities of bits.

As the communication of the tire pressure detection element and the signal conversion element are based on Bluetooth technology, the user can use a mobile device (such as a smart phone or a tablet computer) to control the tire pressure detection element and the signal conversion element. In addition to being an ordinary converter, the signal conversion element may also be a vehicular charging device (such as an electric cigarette lighter or an electric charger). Thereby, the mobile device plugged in the signal conversion element can be charged and transmit signals simultaneously. Thus, the user can operate the signal conversion element with his mobile device more easily. In one embodiment, the tire pressure detection element and the signal conversion element can undertake bidirectional communication, receiving and transmitting information simultaneously. Since the original signals of the tire pressure detection element are Bluetooth signals. Therefore, the tire pressure detection element has further more applications. For example, the tire pressure detection element of the user's vehicle can exchange information with the tire pressure detection element of the vehicle passing by.

In conclusion, the present invention proposes a tire pressure detector set with a Bluetooth signal conversion function, which uses a tire pressure detection element to detect the information of the wheel and transmit the Bluetooth signals of the information to a signal conversion element. The signal conversion element undertakes data format conversion to convert the Bluetooth signals into RF signals according to the model code of the vehicle and the data format required by the in-vehicle central control system and then transmits the RF signals to the in-vehicle central control system. The signal conversion element is installed inside the vehicle and near the in-vehicle central control system, which can guarantee that the in-vehicle central control system can receive complete data and prevent that the RF signals of different vehicles interfere with each other. Further, it is unnecessary for the present invention to equip each wheel with a signal conversion element. Thus, the equipment cost is reduced. The present invention stores data formats in the signal conversion element or a cloud database, which makes a tire pressure detection element of an arbitrary manufacturer adapted to all model codes of vehicles. Therefore, the user has more options in buying a tire pressure detection element.

The embodiments described above are only to exemplify the present invention but not to limit the scope of the present invention. Any equivalent modification or variation according to the spirit of the present invention is to be also included within the scope of the present invention.

What is claimed is:

1. A tire pressure detector set with a Bluetooth signal conversion function, comprising
at least one tire pressure detection element installed in a wheel of a vehicle, detecting information of said wheel, and transmitting a Bluetooth signal; and
a signal conversion element installed in said vehicle, receiving said Bluetooth signal, converting data encoding format depending on a model code of said vehicle and a data format required by an in-vehicle central control system to convert said Bluetooth signal into a radio frequency signal, transmitting said radio frequency signal to a wireless radio frequency receiver of said in-vehicle central control system.

2. The tire pressure detector set with a Bluetooth signal conversion function according to claim 1, wherein said signal conversion element is a vehicular charging device or purely a conversion element.

3. The tire pressure detector set with a Bluetooth signal conversion function according to claim 1, wherein said tire pressure detection element detects temperature and pressure of said wheel and detects voltage of said tire pressure detection element.

4. The tire pressure detector set with a Bluetooth signal conversion function according to claim 1, wherein said tire pressure detection element and said signal conversion element respectively have a first Bluetooth module and a second Bluetooth module, and wherein said first Bluetooth module transmits said Bluetooth signal to said second Bluetooth module.

5. The tire pressure detector set with a Bluetooth signal conversion function according to claim 1, wherein a first microprocessor is installed in said tire pressure detection element and fill said information of said wheel in a data format of said Bluetooth signal.

6. The tire pressure detector set with a Bluetooth signal conversion function according to claim 3, wherein a first microprocessor is installed in said tire pressure detection element and fill said information of said wheel in a data format of said Bluetooth signal.

7. The tire pressure detector set with a Bluetooth signal conversion function according to claim 1, wherein a second microprocessor is installed in said signal conversion element and converts said Bluetooth signal into said radio frequency signal.

8. The tire pressure detector set with a Bluetooth signal conversion function according to claim 1, wherein a radio frequency transmitter is installed in said signal conversion element and transmits said radio frequency signal to said in-vehicle central control system.

9. The tire pressure detector set with a Bluetooth signal conversion function according to claim 1, wherein said radio frequency signal has a frequency of 316 MHz and a frequency of 433 MHz.

10. The tire pressure detector set with a Bluetooth signal conversion function according to claim 1, wherein said signal conversion element stores data formats of different model codes of vehicles.

11. The tire pressure detector set with a Bluetooth signal conversion function according to claim 1, wherein said data formats are stored in a cloud database and downloaded by said signal conversion element.
